(19) United States
(12) Patent Application Publication
(10) Pub. No.: US 2016/0026217 A1
(43) Pub. Date: Jan. 28, 2016

(54) SHADELESS TOUCH HAND-HELD ELECTRONIC DEVICE AND COMPUTER-EXECUTED METHOD

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/743,464

(22) Filed: Jun. 18, 2015

(30) Foreign Application Priority Data
Jul. 25, 2014 (CN) 201410361854.2
Sep. 30, 2014 (CN) 201410522742.0

(51) Int. Cl. G06F 1/16; G06F 3/041; G06F 3/0354

(52) U.S. Cl. CPC G06F 1/1626; G06F 3/03547; G06F 3/041; G06F 2203/04104

(57) ABSTRACT

A hand-held electronic device with a shadeless single-hand multi-finger touch comprises a touch-sensing cover, a panel and a control unit. The touch-sensing cover has a cover and a touch-sensing structure. Partial or total area of the touch-sensing structure is disposed on the cover. The panel is disposed on the other side of the hand-held electronic device opposite the touch-sensing cover. The control unit electrically connected to the touch-sensing cover and the panel executes the steps comprising: displaying information, having a data structure, on the panel; and receiving a single-hand multi-finger input operation from a user holding the touch-sensing cover, and executing a link instruction corresponding to the selected data structure, wherein the multi-finger input operation comprises sequentially or simultaneously performed a multi-finger operations of sliding, clicking, rotating or a combination thereof.

### CROSS REFERENCE TO RELATED APPLICATIONS

This Non-provisional application claims priority under 35 U.S.C. §119(a) on Patent Application No(s). 201410361854.2 filed in People's Republic of China on Jul. 25, 2014 and Patent Application No(s). 201410522742.0 filed in People's Republic of China on Sep. 30, 2014, the entire contents of which are hereby incorporated by reference.

### BACKGROUND

1. Technical Field

The invention relates to a hand-held electronic device, and more particularly to a shadeless touch hand-held electronic device and a computer-executed method.

2. Related Art

With the progress of technologies, various novel digital devices are invented, such as cell phones, tablet computers, ultrabooks, or GPS (Global Positioning System) navigation device, etc. In addition to conventional input or control manners by keyboard or mouse, utilizing the touch-control technique to operate the digital device is a straight and popular operative manner. The touch display device has a friendly and intuitive input operation interface, and therefore users of all ages can manipulate the touch display device by fingers or a stylus.

As to the common and conventional hand-held electronic device with the touch function, the touch operations are all directly executed on the display panel. However, for the operation on the panel, fingers or a stylus will shade the user's view or the software item displayed on the display panel, such that the user may erroneously touch and open an undesired link arranged in a high information content density on the display panel by user's finger or need to rely on an additional stylus to perform the touch operation. To avoid the above situation, certain hand-held electronic devices adopt a design where the touch operation zone is separated from the display panel, such as disclosed by the U.S. Pat. No. 5,825,352 (Logitech).

However, such design will enlarge the size of the electronic device and go against the tendency of the hand-held electronic device towards lightness, thinness and compactness, so as not to be easily carried out in the small-sized product such as tablet computer and cell phone. Moreover, the technique disclosed by the U.S. Pat. No. 5,825,352 (Logitech) also can't solve the problem of that user's view is easily shaded by user's finger in the operation of the hand-held electronic device caused by the finger.

In addition, because a user needs to contact the touch panel with fingers or stylus to control or operate the electronic device, it often scratches the panel. Besides, when operating well-known hand-held electronic device with touch control function, it usually requires one hand to hold the hand-held electronic device and the other hand to execute operation on the panel. If using just one hand to hold and operate the device, only the user's thumb can manipulate the device and thus efficiency, accuracy and convenience of manual operation are reduced and limited.

Furthermore, when the user uses the hand-held electronic device under the sun, the sunlight visibility of the display panel is still an ineffectively unsolved problem. Because the user can neither see the information on the display panel under sun, nor operate by his two hands to timely and effectively click to reply to an e-mail or facebook information.

Furthermore, the above-mentioned panel also needs to be configured with the rare earth transparent touch-sensing layer such as ITO (indium tin oxide) so as to be kept in high transparent display performance. Since the rare earth metal indium is unceasingly consumed, the cost of the product is increasingly higher. Besides, the conductivity of the rare earth metal is worse than that of the normal metal, such that the detection sensitivity for touch is restricted. Therefore, using the rare earth as the transparent touch-sensing layer in the touch display panel is disadvantageous to the environmental resources and energy conservation. Furthermore, the slide distance of the finger is increased with the expanding size of the panel, so the touch-sensing layer area and the cost are daily increased, and the efficiency and the convenience of the manual operation are also deteriorated.

In addition, because user's finger or stylus needs to contact the touch panel for controlling or operating the electronic device, it often scratches the panel. Besides, when operating well-known hand-held electronic device with touch control function, it usually requires one hand to hold the hand-held electronic device and the other hand to execute operation on the panel. If using just one hand to hold and operate the device, only the user's thumb can manipulate the device and thus reduce efficiency, accuracy and convenience of manual operation. The data cannot be transmitted to another electronic device in a wireless manner by single-hand holding and multi-finger touch gesture at the same time, and the manipulation convenience of the data sharing over the user community cannot be expanded.

Therefore, an aspect of the invention is to provide a shadeless touch hand-held electronic device which can prevent the user's view from being shaded by fingers, decrease the dependency on the additional stylus, reduce the scratch problem, and is suitable to be operated by one hand.

In addition, an aspect of the invention is to provide a shadeless touch hand-held electronic device and a computer-executed method, which can enhance convenience of single-hand multi-finger manipulating and the information selecting accuracy without designing a new software recovery menu mechanism to correct the inadvertent touch.

### SUMMARY

Aspects of the invention is to provide a shadeless touch hand-held electronic device which can prevent the user's view from being shaded by fingers, reduce the scratch problem, and is suitable to be operated by one hand.

A shadeless touch hand-held electronic device is provided. The hand-held electronic device comprises a touch-sensing cover, a panel and a control unit. The touch-sensing cover has a cover and a touch-sensing structure. Partial or total area of the touch-sensing structure is disposed on the cover. The panel is disposed on the other side of the hand-held electronic device opposite the touch-sensing cover. The control unit is electrically connected to the touch-sensing cover and the panel, and executes steps comprising: displaying information, having a data structure, on the panel; and receiving multi-finger input operation with single-hand from a user holding the touch-sensing cover, and executing a link instruction corresponding to the selected data structure. The multi-finger input operation comprises sequentially or simultaneously performed a multi-finger operations of sliding, clicking, rotating or a combination thereof.

In one embodiment, the multi-finger input operation comprises: receiving a sliding of a first finger; providing a positioning cursor on the panel, and generating a corresponding cursor motion to follow the sliding of the first finger; and executing the link instruction by a second finger input operation received from the touch-sensing structure when the cursor moves to a position of the selected data.

In one embodiment, the steps executed on the hand-held electronic device further comprises: transmitting the selected data to a targeted electronic device.

In one embodiment, the hand-held electronic device according to claim 3 further comprises a sensing unit, which is signaling the control unit and generating a transmission signal by the multi-finger input operation. The control unit transmits the selected data to the targeted electronic device according to the transmission signal.

In one embodiment, the transmission signal is generated according to a sliding direction or a sliding angle by the multi-finger input operation.

In one embodiment, the user operates the hand-held electronic device by one hand, and the touch-sensing cover faces a light source, or the back of the panel faces the light source.

In one embodiment, a wiring connecting to the touch-sensing structure is gathered to a single side for wiring outlet.

In one embodiment, the width of the touch-sensing structure is less than the width of the cover by 5% to 10%.

In one embodiment, the area of the touch-sensing structure and area of the panel have a ratio relationship.

In one embodiment, the touch-sensing structure comprises metal mesh, metal nanowires, transparent conducting film, carbon nanotube or graphene.

In one embodiment, the touch-sensing cover further comprises a functional component, the cover comprises a first portion and a second portion, and the functional component is disposed on the second portion.

In one embodiment, partial or total area of the touch-sensing structure is disposed on the first portion.

In one embodiment, the functional component comprises a radio frequency identification module, a near field communication module, an antenna module, a Bluetooth module, an infrared module, a zigbee module, a wireless charging module, a palmprint recognition module or a combination thereof.

A computer-executed method is applied to a shadeless touch hand-held electronic device for multi-finger operation by single hand. The hand-held electronic device comprises a touch-sensing cover, a panel and a control unit. The computer-executed method executed on the hand-held electronic device comprises following steps of: displaying information, having a data structure, on the panel; and receiving multi-finger input operation by single hand while a user holding the touch-sensing cover, and executing a link instruction corresponding to the selected data structure. The multi-finger input operation comprises sequentially or simultaneously performed a multi-finger operations of sliding, clicking, rotating or a combination thereof.

In one embodiment, the multi-finger input operation comprises: receiving a sliding of a first finger; providing a positioning cursor on the panel, and generating a corresponding cursor motion to follow the sliding of the first finger; and executing the link instruction by a second finger input operation received from a touch-sensing structure when the cursor moves to a position of the selected data.

In one embodiment, the method further comprises a step of transmitting the selected data to a targeted electronic device.

In one embodiment, the hand-held electronic device further comprises a sensing unit. The sensing unit is signaling the control unit and generating a transmission signal by the multi-finger input operation. The control unit transmits the selected data to the targeted electronic device according to the transmission signal.

In one embodiment, the transmission signal is generated according to a sliding direction or a sliding angle by the multi-finger input operation.

In one embodiment, the touch-sensing cover has a cover and a touch-sensing structure, and the area of the touch-sensing structure and area of the panel have a ratio relationship.

In one embodiment, the touch-sensing structure comprises metal mesh, metal nanowires, transparent conducting film, carbon nanotube or graphene.

In summary, the user can perform the touch operation on the touch-sensing cover of the shadeless touch hand-held electronic device in the shadeless touch hand-held electronic device and its touch-sensing cover. So, the finger cannot shade the user's view or the software target or software object displayed on the panel. Of course, the inadvertent touch phenomenon will not occur when opening the link of the high information density frame. In addition, because the electronic device is operated on the touch-sensing cover, the dependency on the stylus can be decreased, and the panel scratching problems can be decreased. In addition, because the user can perform the touch operation on the touch-sensing cover, the user can use one hand to hold the device and use the index finger and/or middle finger of the same hand to operate the electronic device. Compared with the conventional condition where only the thumb of one hand can be used to perform the manipulation, the disclosure also has the relatively high efficiency and convenience of the manual operation. Also, the multi-finger manipulating convenience with single hand and the information selecting accuracy are also enhanced, and the high quality and wonderful user experience can be implemented.

In addition, in one embodiment, the shadeless touch hand-held electronic device is accessible in the strong light environment, for example, the device is able to use under the outdoor sun or the indoor strong illumination lamp. When the user operates the shadeless touch hand-held electronic device by one hand and the touch-sensing cover faces the light source in the strong light environment (the panel faces the user), the back of the panel faces the light source of the strong light environment, the touch-sensing cover can shield and block the light source to enhance the readability, and the operation or input control can be continuously performed with one hand. Furthermore, the user can use only one hand to hold the device, and the index finger and/or middle finger of the hand can perform the control input. Thus, the convenience of operating the shadeless touch hand-held electronic device under the strong light source (e.g., sunlight) by one hand can be enhanced. In addition, the operating flexibility using the index finger or middle finger on the touch-sensing cover is significantly increased as compared with the operating flexibility using the thumb in the conventional single-hand manipulation, and novel user experience of the single-hand holding and multi-finger touching can be created. In addition, the wireless transmission between the functional component disposed on the second portion of the cover and another electronic device can be performed to enhance the operation convenience.

In addition, the invention uses single-hand holding and multi-finger touch gesture to wirelessly transmit the data to other electronic devices, so that the manipulation convenience of the data sharing over the user community can be expanded.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 is a schematically used view showing a shadeless touch hand-held electronic device according to a first embodiment of the invention;

FIG. 2 is a functional block diagram showing the shadeless touch hand-held electronic device of FIG. 1;

FIG. 3 is a schematic view showing the hand-held electronic device of FIG. 1 at another viewing angle;

FIG. 4 is a functional block diagram showing a touch-sensing cover according to one embodiment of the invention;

FIG. 5A is a pictorial view showing a user operating the touch-sensing cover by two fingers;

FIG. 5B is a schematic view showing a capacitance change of two non-overlapped fingers after the touch-sensing structure is scanned;

FIG. 6 is another schematically used view showing the hand-held electronic device;

FIG. 7 is a schematic view showing a shadeless touch hand-held electronic device according to a second embodiment of the invention;

FIG. 8 is a schematic block diagram showing the shadeless touch hand-held electronic device of FIG. 7;

FIG. 9A is a schematic view showing the shadeless touch hand-held electronic device of FIG. 7 at another viewing angle;

FIG. 9B is a schematic view showing the shadeless touch hand-held electronic device of FIG. 9A at another viewing angle;

FIG. 10 is a schematic view showing another embodiment of the touch-sensing structure of FIG. 9A;

FIGS. 11A and 11B are flow charts showing steps of a computer-executed method according to the preferred embodiment of the invention;

FIG. 12 is a schematic views showing operations of the shadeless touch hand-held electronic device of FIG. 7;

FIG. 13 is another schematic view showing operations of the shadeless touch hand-held electronic device of FIG. 7;

FIG. 14 is still another schematic view showing operations of the shadeless touch hand-held electronic device of FIG. 7; and

FIGS. 15A and 15B are other schematic views showing operations of the shadeless touch hand-held electronic device of FIG. 7.

### DETAILED DESCRIPTION OF THE INVENTION

The embodiments of the invention will be apparent from the following detailed description, which proceeds with reference to the accompanying drawings, wherein the same references relate to the same elements.

The disclosure provides a design around U.S. Pat. No. 5,825,352 of Logitech, Inc to get rid of the patent infringement issue, and creates also provides better user experiences, which are better than those of the product technology of Logitech, Inc. It is to be noted that details of the hand-held electronic devices with the shadeless touches according to the first and second embodiments of the invention are described, and then the shadeless touch hand-held electronic device according to the second embodiment will be described, as an example, to further illustrate the computer-executed method of the invention.

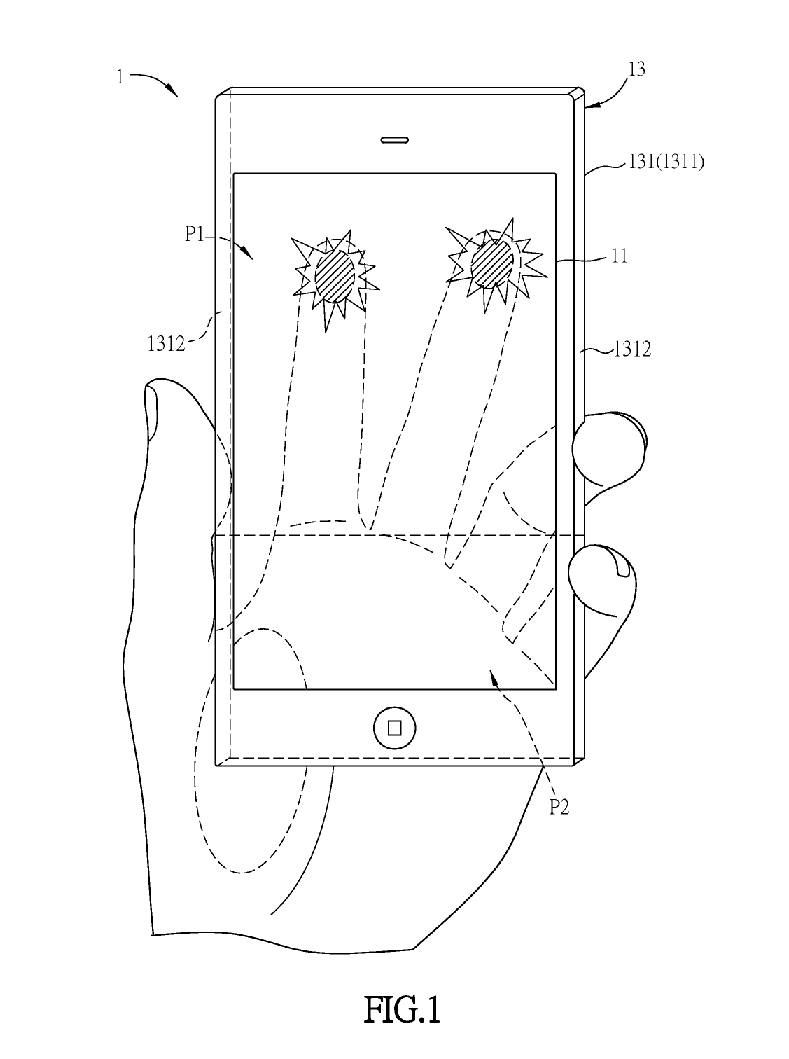

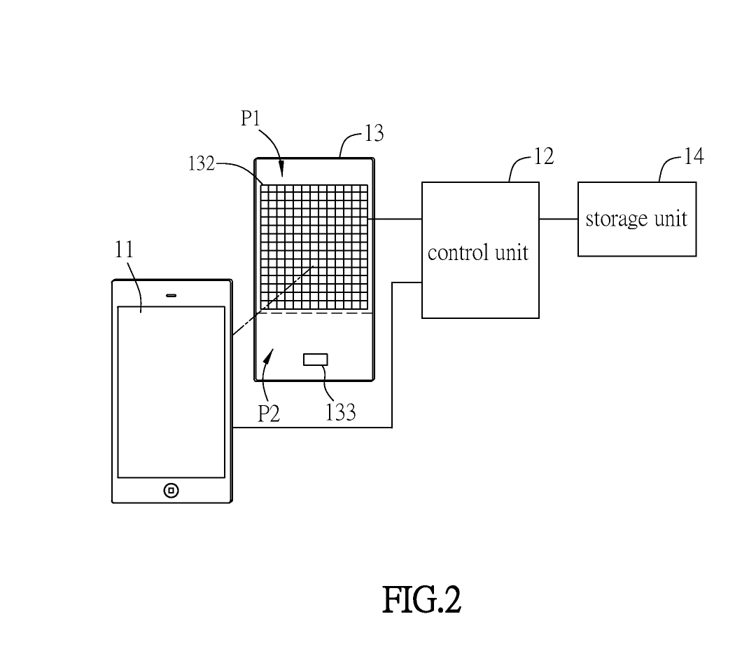

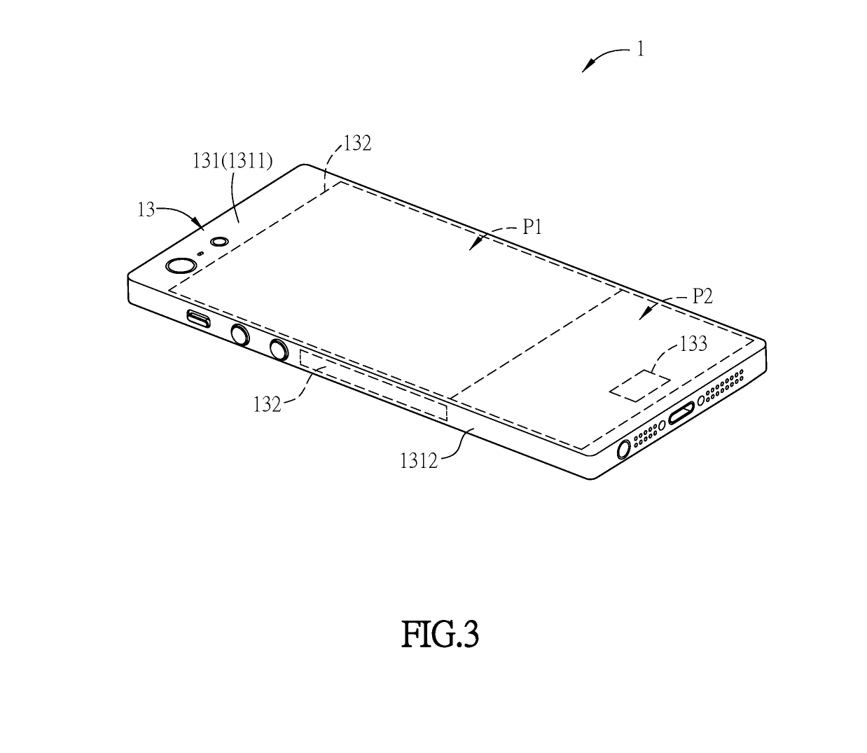

Referring to FIGS. 1 to 3, FIG. 1 is a schematically used view showing a shadeless touch hand-held electronic device according to a first embodiment of the invention, FIG. 2 is a functional block diagram showing the shadeless touch hand-held electronic device of FIG. 1, and FIG. 3 is a schematic view showing the hand-held electronic device of FIG. 1 at another viewing angle.

A hand-held electronic device 1 with the shadeless touch (hereinafter referred to as hand-held electronic device 1) may be, for example, a smart phone, a tablet computer (or tablet), a personal digital assistant (PDA), a global positioning system (GPS) or the like. Herein, a hand-held smart phone will be described as an example. In addition, the assemblies of the hand-held electronic device 1 of this embodiment may be implemented in the combination of the hardware, software or firmware of one or multiple signal processing and/or integrated circuits.

The hand-held electronic device 1 comprises a panel 11, a control unit 12 and a touch-sensing cover 13. In addition, the hand-held electronic device 1 may further comprise a storage unit 14. The control unit 12 is electrically connected to the panel 11, the touch-sensing cover 13 and the storage unit 14.

The panel 11 is disposed on one side of the hand-held electronic device 1, such as the side of the hand-held electronic device 1 which faces the user's view. The panel 11 may be, for example but without limitation to, a liquid crystal display panel, an organic electroluminescent diode display panel, a touch display panel or an electrophoresis display panel. In addition to an ordinary frame, the panel 11 may also provide a graphic user interface (GUI) to the user, wherein the GUI may have one or multiple graphs to present various known software components on the panel 11 by way of graphs (e.g., icons).

The touch-sensing cover 13 comprises a cover 131, a touch-sensing structure 132 and a functional component 133. The cover 131 is disposed on the other side of the hand-held electronic device 1 opposite the panel 11 (i.e., the opposite side to the display surface). The cover 131 comprises a first portion P1 and a second portion P2. In this embodiment, the first portion P1 neighbors the second portion P2, the first portion P1 is disposed on the upper half portion of the cover 131 (the upper half portion does not necessary represent 50%), and the second portion P2 neighbors the first portion P1 and is disposed on the lower half portion of the cover 131. In different embodiments, the first portion P1 may also not neighbor the second portion P2, and it is not limited thereto. In addition, partial or total area of the touch-sensing structure 132 may be disposed on the first portion P1. In other words, the area of the touch-sensing structure 132 (first portion P1) of the touch-sensing cover 13 of this embodiment is less than the area of the panel 11, the area of the touch-sensing structure 132 is proportional to the area of the panel 11, and the control unit 12 converts the touch-sensing points of the touch-sensing cover 13 into the corresponding position of the panel 11 according to the proportional relationship.

The cover 131 of this embodiment has a cover 1311 and a sidewall 1312 extending from at least a portion of the periphery of the cover, and the first portion P1 comprises a portion of the cover 1311 and a portion of the sidewall 1312. The first portion P1 occupies about ⅔ of the region of the cover 1311 between the two sides of the sidewall 1312. In addition, the touch-sensing structure 132 is electrically connected to the control unit 12. In this embodiment, the touch-sensing structure 132 is disposed on a portion of the cover 1311, and further extended and disposed on a portion of the sidewall 1312 on two sides. In other words, the touch-sensing structure 132 of this embodiment directly extends from the cover 1311 of the first portion P1 to the two lateral sides of the first portion P1 to enlarge the area where the user executes the operation. In other embodiments, the touch-sensing structure 132 may also be disposed on the cover 1311 of the first portion P1 only. In addition, the physical button (e.g., sound button) may also be replaced with the touch-sensing structure 132 in this embodiment. However, it is not limited thereto.

The hand-held electronic device 1 of this embodiment can allow the user to use fingers, for example, to perform the touch operation on the first portion P1 of the touch-sensing cover 13, and the panel 11 can display the corresponding operation instruction according to the user's operation gesture (or hand gesture) to interact with the graphic user interface displayed on the panel 11. For example, when the user's finger slides on the touch-sensing cover 13, the panel 11 also has a corresponding cursor (e.g., arrow or hand shape) sliding therewith at the corresponding position. Herein, the touch may be, for example, implemented by the user by using the finger or stylus contacting or approaching the touch-sensing cover 13. In addition, the interaction with the graphic user interface may be, for example, that the user uses the finger to perform tapping, enlarging or moving by touching on the first portion P1 of the touch-sensing cover 13. For example, when the user's finger taps on the first portion P1 of the touch-sensing cover 13, the panel 11 executes the object corresponding to the position information. Thus, the object displayed on the panel 11 can be executed through the direct control on the touch-sensing cover 13, so that the shadeless touch can be implemented. The so-called “touch” may comprise the operation hand gesture or the operation gesture, such as tapping once or tapping multiple times, sliding once or sliding multiple times (e.g., sliding from left to right, sliding from right to left, sliding upward or downward), the sequential tapping of multiple fingers, sliding of multiple fingers, or the like. In addition, the operations corresponding to the operation gestures may be set when the hand-held electronic device 1 is shipped out, and may also be reconfigured by the users according to their different using habits. Thus, as shown in FIG. 1, the user can read the contents displayed by the panel 11 on the front side of the hand-held electronic device 1, and perform the input on the first portion P1 of the touch-sensing cover 13 on the backside.

In addition, in one embodiment, the hand-held electronic device 1 is accessible in the strong light environment (e.g., under the outdoor sun or the indoor strong illumination lamp). Because the user can use one hand to operate the hand-held electronic device 1 with the touch-sensing cover 13 facing the light source of the strong light environment (with the panel 11 facing the user), the back of the panel 11 faces the light source of the strong light environment, and the touch-sensing cover 13 can shield and block the light source to enhance the readability. Then, the user continues using one hand to perform the above-mentioned operation or input control. Furthermore, the user can use one hand to hold hand-held electronic device 1, and use the index finger and/or middle finger of the same hand to perform the control input. Thus, it is possible to enhance the convenience of operating the hand-held electronic device 1 by using just one hand under the strong light source (e.g., sunlight). In addition, using the index finger or middle finger to perform the operation on the touch-sensing cover 13 is much more flexible than using the thumb in the conventional single-hand manipulation, and the novel user experience of single-hand holding and multi-finger touching can be provided and created.

The touch-sensing structure 132 may be disposed on an inner surface of the first portion P1 facing the panel 11 (i.e., inside the hand-held electronic device 1), or disposed on an outer surface of the first portion P1 away from the panel 11 (i.e., outside the hand-held electronic device 1). The touch-sensing structure 132 of this embodiment is, for example, a capacitive touch-sensing structure, is formed on the inner surface of the first portion P1 facing the panel 11, and is directly formed on the cover 1311 and two sidewalls 1312 of the first portion P1. In different embodiments, if the touch-sensing structure 132 is disposed on the outer surface of the first portion P1 away from the panel 11, then a protection layer has to be added to protect the touch-sensing structure 132. In addition, it is to be noted that the material of the cover 131 may be glass or another material, and the cover 131 is one piece in the hand-held electronic device 1. In other words, the touch-sensing cover 13 is not an additionally added member (the additionally added member may be, for example, the protection cover of the electronic device). Thus, after the touch-sensing cover 13 being removed from the hand-held electronic device 1, the internal components of the hand-held electronic device 1, such as a battery, an integrated circuit or the like, can be seen. In one embodiment, a circuit board, a battery or a memory card is further disposed between the touch-sensing cover 13 and the panel 11.

In addition, the touch-sensing structure 132 may comprise an emitting circuit and a receiving circuit (i.e., the so-called Tx and Rx, not shown), and the material thereof may be an conductive layer (a transparent conductive layer, such as indium tin oxide (ITO), indium zinc oxide, fluorine-doped tin oxide, aluminum-doped zinc oxide (AZO) or gallium-doped zinc oxide may be adopted), metal mesh, metal nanowires, transparent conducting film, carbon nanotube or graphene. However, it is not limited thereto. If the metal mesh, metal nanowires or graphene is used as the material of the touch-sensing structure 132, Tx and Rx may further be used to perform the wireless information or wireless power transmission (e.g., Bluetooth wireless communication or wireless charging).

In addition to the cover 1311 and the sidewall 1312 of the first portion P1, the touch-sensing structure 132 may further be disposed at another position of the hand-held electronic device 1 where the panel 11 is not shaded, such as the top surface thereof, according to different requirements. Thus, when the user wants to perform the operation on the touch-sensing cover 13, as shown in FIG. 1, the display on the panel 11 will not be shaded by the finger, and the inadvertent touch problems may be further avoided. In addition, the advantages of using the touch-sensing cover 13 to let the user perform the touch input reside in that the touch-sensing cover 13 needs not to be made of the transparent touch sensing material (e.g., ITO) to satisfy the display performance of the panel 11. Thus, the material selection becomes more resilient, the cost can be controlled more easily, and trouble of etal fringe interference will not happen when the metal mesh is disposed on the panel.

In some embodiments, the hand-held electronic device 1 may further comprise another touch-sensing structure (not shown), which may be disposed on the panel 11, so that the panel 11 becomes the touch display panel. Thus, the user can perform the shadeless touch operation on the first portion P1 of the cover 131, and another touch-sensing structure may also provide another operation interface for communicating with the apparatus. Therefore, the user can choose to perform the shadeless touch operation on the first portion P1 of the cover 131, and may also choose to directly operate the hand-held electronic device 1 on the touch display panel, or to operate the hand-held electronic device 1 on the first portion P1 of the cover 131 and the touch display panel simultaneously.

The functional component 133 is disposed on the second portion P2 and is electrically connected to the control unit 12. The second portion P2 of this embodiment only comprises a portion of the cover 1311, and the functional component 133 is disposed on the outer surface of the cover 1311 facing the panel 11 (a protection layer may be needed to protect the functional component 133). In different embodiments, however, the second portion P2 may also comprise a portion of the cover 1311 and a portion of the sidewall 1312, and the functional component 133 may also be disposed on the inner surface of the cover 1311 facing the panel 11 without any restriction. The functional component 133 may be a radio frequency identification (RFID) module, a near field communication (NFC) module, an antenna module, a Bluetooth module, an infrared module, a zigbee module, a wireless charging module or a palmprint recognition module, or a combination thereof without any restriction. In some embodiments, the functional component 133 is the radio frequency identification module and disposed on the outer surface of the second portion P2. According to the working principle of RFID, when the label enters the magnetic field and if the special radio frequency signal outputted from the reader is received, the product information stored in the module can be transmitted according to the energy obtained by the induced current, or a signal (i.e., active tag or active label) with a certain frequency is actively transmitted. The reader reads and decodes the information, and outputs the decoded information to the central information system which performs associated data processing. Thus, data transmission with another electronic apparatus can be performed through the radio frequency identification technology.

In addition, if the functional component 133 is the wireless charging module, then the hand-held electronic device 1 is wirelessly charged through electrodes of the wireless charging module. If the functional component 133 is the palmprint recognition module, then the user can store his/her palmprint in the storage unit 14 in advance. When the hand-held electronic device 1 is to be activated or operated, the palm can touch a specific region on the second portion P2, and the control unit 12 can compare the received palmprint within the specific region with the pre-stored palmprint. If they conform to each other, then the hand-held electronic device 1 can be activated or operated, and receive the user's input operation. If they do not conform to each other, then the control unit 12 determines that the user is not an authorized user, and the hand-held electronic device 1 cannot be permitted to neither activate nor operate. Thus, by disposing the functional component 133 on the second portion P2 of the cover 131, the user can perform data, signal or power transmission with other electronic apparatuses through the functional component 133, thereby increasing the using convenience.

Referring again to FIG. 2, the control unit 12 is disposed on a circuit board inside the hand-held electronic device 1, and may be composed of one single processing circuit or multiple processing circuits. The control unit 12 can control the contents displayed by the panel 11, and may also control the operation of the touch-sensing cover 13. In addition, the storage unit 14 is a storage medium of the hand-held electronic device 1, and may be a memory inside the hand-held electronic device 1, or a memory (e.g., cloud memory or cloud storage) outside the hand-held electronic device 1 without any restriction. The storage unit 14 may comprise, for example, a read-only memory (ROM), a random access memory (RAM), a flash memory, a field-programmable gate array (FPGA) or any other memory without any restriction. In addition, one or multiple programs can be stored in the storage unit 14, and configured to be executed by the control unit 12, which may comprise one or multiple processors. In addition, the storage unit 14 may also store an operation system, an application program, a data processing program, electronic data of various formats, and the like. The operation system is a program for managing the computer hardware, firmware and software resource, and the application program may be, for example, a text editing program, an e-mail program or others. In this embodiment, the control unit 12 comprises, for example, a central processing unit (CPU), and executes these programs.

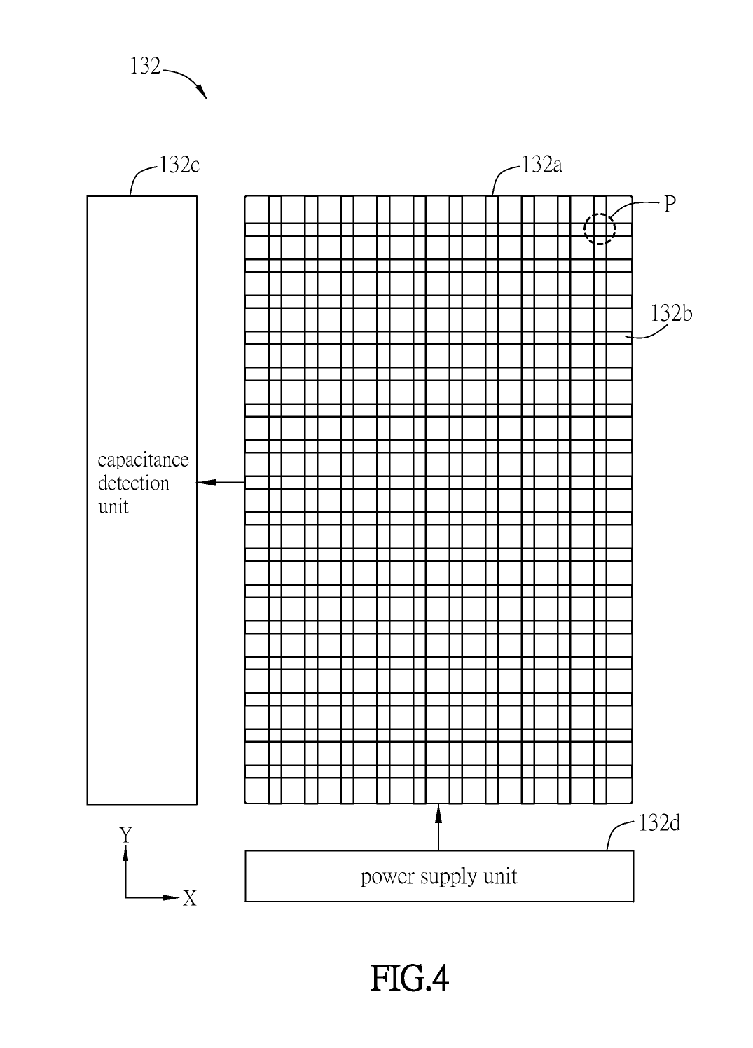

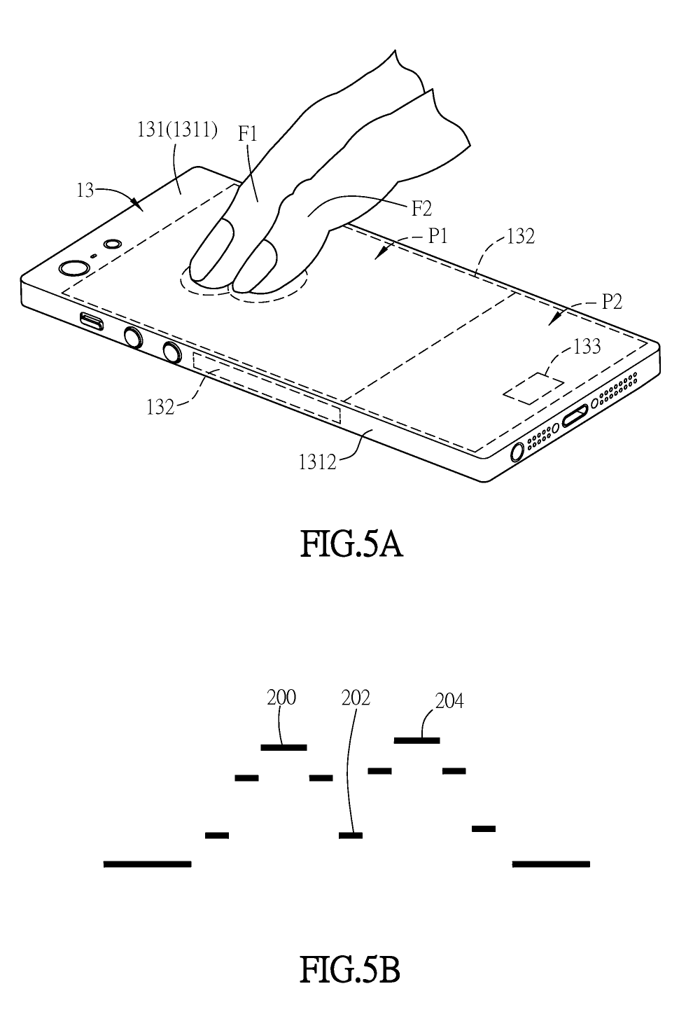

Referring to FIGS. 4 and 5A, FIG. 4 is a functional block diagram showing a touch-sensing cover according to one embodiment of the invention, and FIG. 5A is a pictorial view showing a user operating the touch-sensing cover by two fingers. The touch-sensing structure 132 of the touch-sensing cover 13 is depicted.

The touch-sensing structure 132 of this embodiment may comprise a first sensing layer 132a, a second sensing layer 132b, a capacitance detection unit 132c and a power supply unit 132d.

The first sensing layer 132a and the second sensing layer 132b are electrically connected to the capacitance detection unit 132c through wires. The first sensing layer 132a has multiple first sensing lines separately arranged in a first direction X (e.g., horizontal direction). The second sensing layer 132b is disposed opposite the first sensing layer 132a, and has multiple second sensing lines separately arranged in a second direction Y (e.g., vertical direction). The first sensing layer 132a and the second sensing layer 132b are disposed separately in the space. In detail, the first sensing layer 132a and the second sensing layer 132b are disposed on different planes in the space, and can be electrically isolated from each other through an insulating layer. In addition, these first sensing lines are interlaced with these second sensing lines to form multiple detection points P. The power supply unit 132d can provide a voltage signal to the second sensing line because distances from the first sensing lines to the second sensing lines are very short, and the first sensing lines to the second sensing lines are conductive. Thus, a coupling capacitor is formed at the interlacing position (i.e., detection point P) between each first sensing line and each second sensing line. It is to be noted that the first sensing layer 132a and the second sensing layer 132b of this embodiment are disposed on the inner surface of the cover 131 facing the panel 11, and an insulating layer (not shown) has to be applied to provide the electrical isolation. In different embodiments, however, the first sensing layer 132a may be disposed on the inner surface of the cover 131 facing the panel 11, and the second sensing layer 132b may be disposed on the outer surface of the cover 131 away from the panel 11 (or on the contrary), and the cover 131 may function as electrical isolation between the first sensing layer 132a and the second sensing layer 132b without the provision of the insulating layer.

The capacitance detection unit 132c is electrically connected to these first sensing lines and these second sensing lines respectively, detects coupling capacitance changes between these first sensing lines and these second sensing lines, and thus provides a touch signal, which may be transmitted to the control unit 12, which executes the judgement or analysis to confirm the selected object and generate the corresponding operation. For example, when the user's finger touches or approximately touches a specific detection point P, the finger will change the charge coupling between the first sensing lines and the second sensing lines at the position corresponding to the detection point P, and thus affect the capacitance of the detection point P. The contact position of the user's finger can be judged after the capacitance detection unit 132c being detected the coupling capacitance changes between the first sensing lines and the second sensing lines.

The capacitance detection unit 132c may comprise one or multiple sensing circuits (e.g., sensing ICs) for detecting the capacitance of each detection point P, converting an analog capacitance signal into a digital capacitance signal, and transmitting the digital capacitance signal to the control unit 12 electrically connected to the capacitance detection unit 132c (the control unit 12 is not shown in FIG. 4).

Additionally, in other embodiments, filters may further be provided between these first sensing lines and the capacitance detection unit 132c, wherein the filter may be implemented using the circuit of an inverting amplifier, for example. The filter can eliminate the parasitic capacitance inside the touch-sensing structure, such as capacitance effects between different first sensing lines, capacitance effects between different second sensing lines or capacitance effects between the sensing lines and the ground potential. Briefly, the filter can prevent the signal inputted to the capacitance detection unit 132c from being affected by the capacitance other than the detection point P.

The method of generating the corresponding operations by the touch-sensing structure 132 of the touch-sensing cover 13 through the multi-finger input will be explained.

Referring to FIGS. 5A and 5B, FIG. 5B is a schematic view showing a capacitance change of two non-overlapped fingers after the touch-sensing structure 132 is scanned.

FIG. 5A is a pictorial view showing a user operating the touch-sensing cover by two fingers. The actual contact forms or shapes between the finger tip and the first portion P1, as well as the number of the contact finger(s) are not limited to those depicted in the drawings. In addition, although the operation is performed on the cover 1311 of the first portion P1 in this embodiment, multiple fingers may operate on the cover 1311 and the sidewall 1312 of the first portion P1 in other embodiments without being restricted to the operation shown in the drawings.

In this embodiment, a middle finger F1 and an index finger F2 act as operation fingers. When the middle finger F1 and the index finger F2 simultaneously touch the touch-sensing structure 132 of the cover 131 of the first portion P1, the capacitance detection unit 132c can detect a first peak value 200 and a second peak value 204. The first peak value 200 corresponds to a coupling capacitance change of the middle finger F1 on the touch-sensing structure 132, and the second peak value 204 corresponds to the coupling capacitance change of the index finger F2 on the touch-sensing structure 132. A trough value 202 falls between the first peak value 200 and the second peak value 204, and is generated by a gap between the two fingers. So, it is possible to estimate the input gesture of the user's finger according to the time difference, synchronous movement, relative movement and the like generated by viewing the first peak value 200 and the second peak value 204 of the coupling capacitance change, and the finger's touch signal is transmitted to the control unit 12 to perform the corresponding control operation. Those skilled in the art should understand that if the number of the operating fingers is increased, then the peak values, the number of troughs between the peak values and the applications are correspondingly increased. Thus, the sequential or simultaneously touches and movements of the multiple fingers on the touch-sensing structure 132 can perform different types of operations on the first portion P1 of the touch-sensing cover 13, and implement the method of detecting the finger inputs without shading user's view while operating.

In addition, although the trough value 202 of FIG. 5B is a non-zero coupling capacitance change, the trough value 202 in one embodiment may be zero, and the trough value 202 may change with the change of the distance between the neighboring fingers.

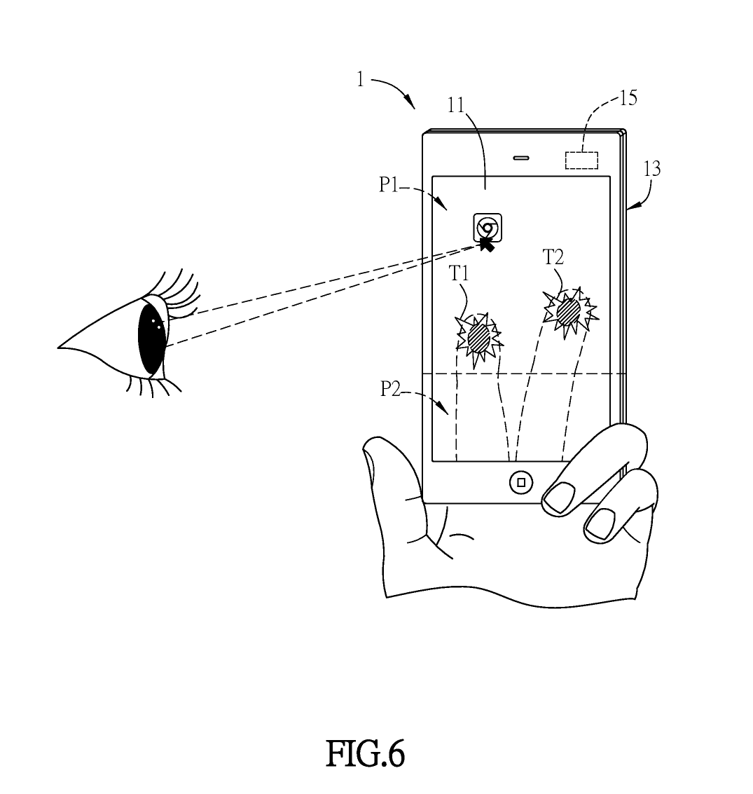

Referring to FIG. 6, FIG. 6 is another view schematic usage view showing the hand-held electronic device.

The hand-held electronic device 1 may further comprise an eye tracking module 15 electrically connected to the control unit 12 (the connection is not shown). The eye tracking module 15 of this embodiment may be an eye tracker, a camera, a photographing device or an infrared detecting device for detecting and capturing the user's eyeball information. The eyeball information may be, for example, an eye image, eye coordinates or a combination thereof. The eyeball information captured by the eye tracking module 15 corresponds to the panel 11 and has the position information, which corresponds to at least one object displayed on the panel 11. It is to be additionally described that the position information needs not to be completely the same as the focus position of the user's eye, and may be corrected into the position of the object, which is closest to the focus position of the user's eye, and can be conveniently selected by the user. The position information will be automatically corrected to the nearest position of the object.

In addition, as shown in FIG. 6, the panel 11 may display an arrow, for example, at the position of the corresponding position information to make the user understand the current position of the corresponding position information. When the eyeball information of the user fluctuates, the position information (arrow) on the panel 11 is also correspondingly moved.

In the following, how the eyeball information captured by the eye tracking module 15 works in conjunction with the finger input detection will be described with reference to FIGS. 4 and 6. All the following operation gestures (hand's operation gestures) are the operation gestures of touches by the finger tips of the user on the first portion P1 of the touch-sensing cover 13. In addition, the finger input detection of this embodiment may be applied to the above-mentioned hand-held electronic device 1, but is not restricted to the device. The method of detecting the finger input detection may comprise the following steps. First, the eye tracking module 15 captures the eyeball information, which may be an eye image, eye coordinates or a combination thereof, for example. Next, the eyeball information has the position information corresponding to the panel 11, and the position information may correspond to at least one object displayed on the panel 11. The object may be, for example, an icon corresponding to an application program. The position information of this embodiment may correspond to the movement to the position of the object nearest to the position information.

Next, the touch-sensing structure 132 is scanned, and the coupling capacitance changes (i.e., the coupling capacitance changes of the detection point P) between these first sensing lines and these second sensing lines of the touch-sensing structure 132 are detected. When one finger touches the touch-sensing structure 132 (tapping or directly contacting), the coupling capacitance is changed and the touch signal is generated. The touch signal is transmitted to the control unit 12. Simultaneously, the control unit 12 of the hand-held electronic device 1 confirms the selected object according to the touch signal. At this time, the received touch signal confirms that the object corresponding to the position information (arrow) is the to-be-selected object. Besides, the selected object may be confirmed by a visible sign (e.g., color change). In other embodiments, however, the visible sign may also be presented by a prompt frame, a shape change (e.g., enlargement), flickering of the selected object or displaying a symbol beside the selected object.

The hand-held electronic device 1 confirms the selected object according to the touch signal, and simultaneously executes the instruction corresponding to the object. In other words, when the touch-sensing structure 132 detects the coupling capacitance change generated by one tapping operation or two tapping operations with one finger, for example, the hand-held electronic device 1 executes the application program corresponding to the object corresponding to the position information. For example, after the tapping of one finger is performed, and the shortcut icon of the browser is confirmed as being selected, the browser is executed.

In addition, in the application to the multi-finger input (e.g., after the user additionally using another finger to touch the touch-sensing structure 132 of the first portion P1), the touch-sensing structure 132 receives two finger touch signals T1 and T2. At this time, the control unit 12 judges the executive action corresponding to the finger touch signals T1 and T2 inputted at two neighboring timings, respectively, as “to move the selected object”. So, when the two fingers continuously contact the touch-sensing structure 132 and slide thereon, the object displayed on the panel 11 will be correspondingly moved in response to the motion paths of the two fingers. It is to be particularly stated that this embodiment only illustrates that one or multiple fingers are used to execute the operation on the touch-sensing structure 132. However, those skilled in the art should easily develop other operation methods according to the description of this embodiment.

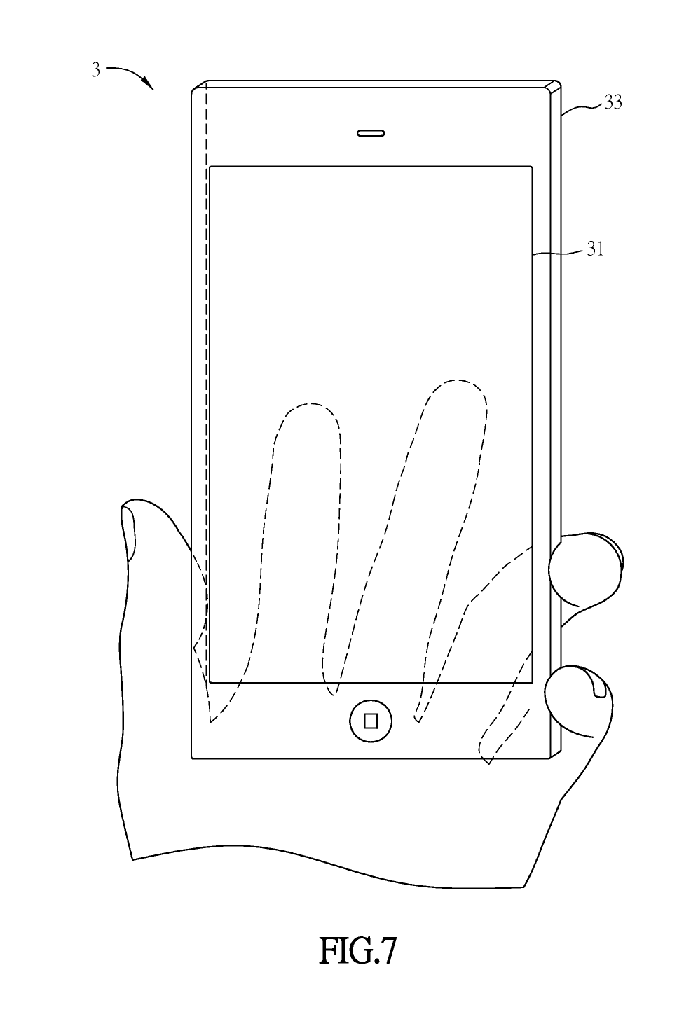

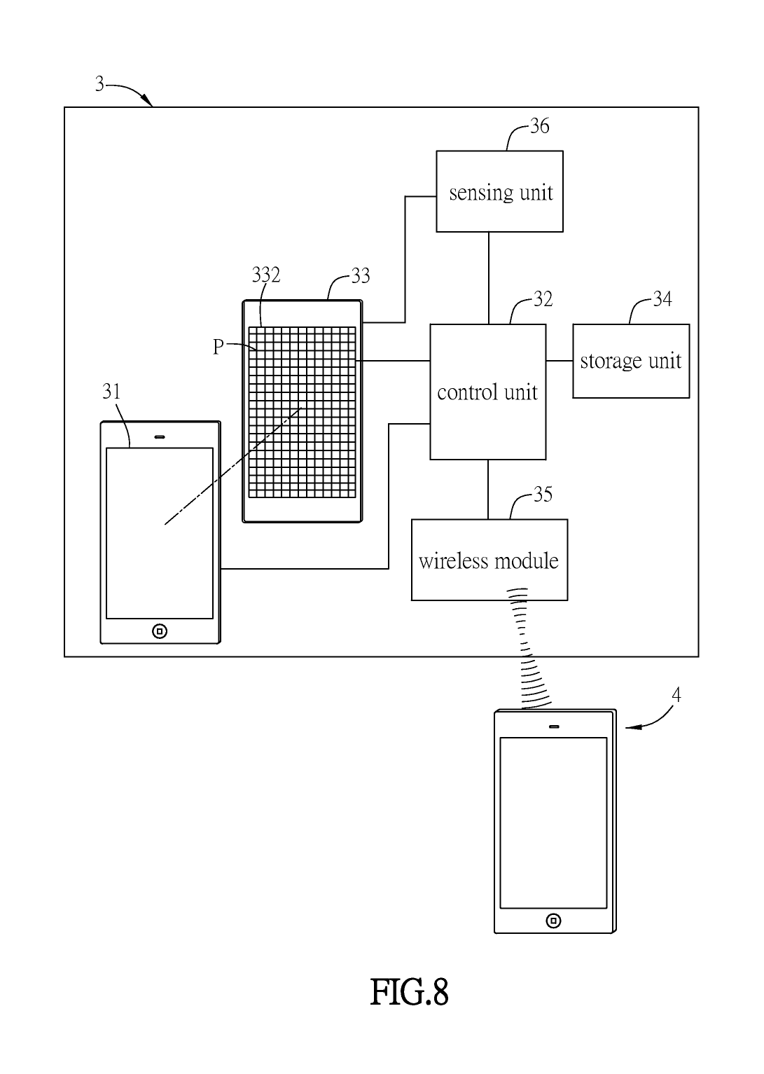

FIG. 7 is a schematic view showing a shadeless touch hand-held electronic device according to a second embodiment of the invention. FIG. 8 is a schematic block diagram showing the shadeless touch hand-held electronic device of FIG. 7. Similarly, a hand-held electronic device 3 of this embodiment comprises a panel 31, a control unit 32 and a touch-sensing cover 33, wherein the detailed implementation thereof may be found in the first embodiment.

Similarly, the touch-sensing cover 33 and the panel 31 are coupled to the control unit 32 respectively, so that the control unit 32 can control the content information displayed by the panel 31, and control a specific position of the touch-sensing cover 33 to be selected for input. In this embodiment, the control unit 32 electrically connected to the touch-sensing cover 33 and the panel 31 executes the steps comprising: displaying information, having a data structure, on the panel 31; and receiving a single-hand multi-finger input operation from a user holding the touch-sensing cover 33 and executing a link instruction corresponding to the information of the selected data structure. The detailed contents of the executed steps will be described later.

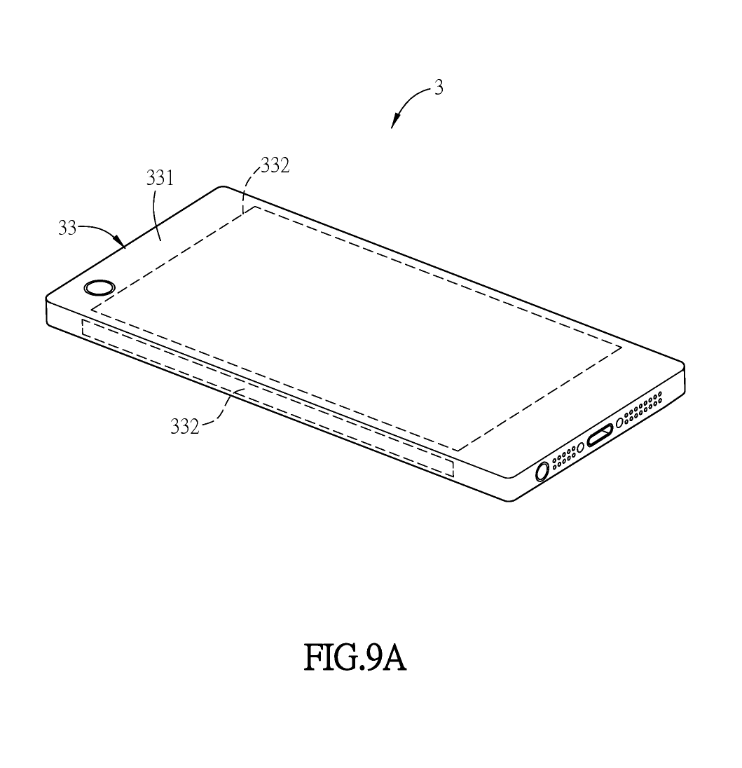

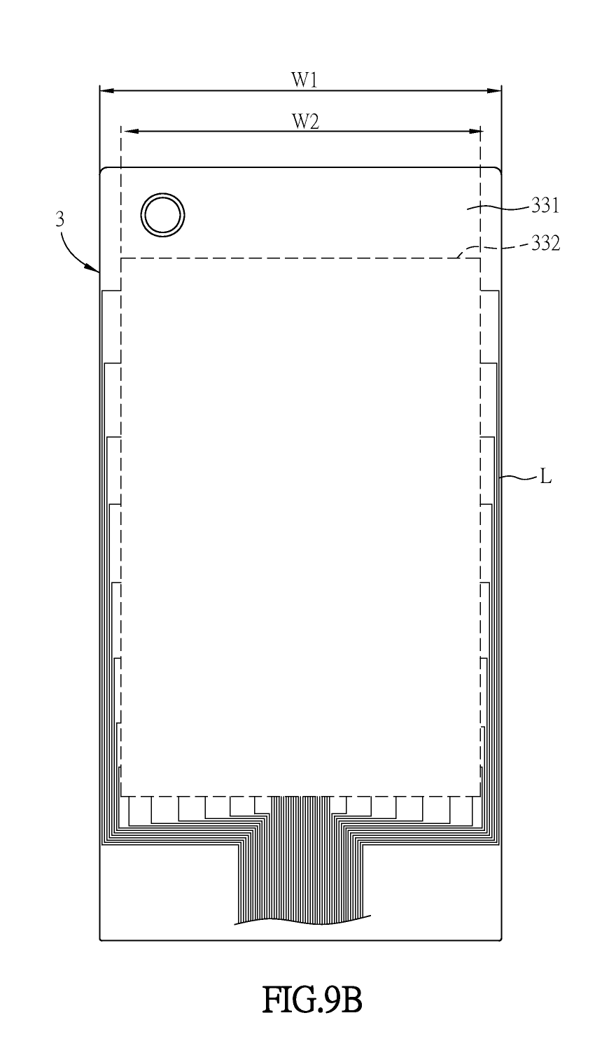

FIG. 9A is a schematic view showing the shadeless touch hand-held electronic device of FIG. 7 at another viewing angle. Referring to FIGS. 7 to 9A concurrently, the touch-sensing cover 33 of this embodiment comprises a cover 331 and a touch-sensing structure 332. Similarly, the cover 331 is disposed on the other side of the hand-held electronic device 3 opposite the panel 31 (a surface opposite the display surface), and partial or total area of the touch-sensing structure 332 may be disposed on the cover 331. In this embodiment, the touch-sensing structure 332 extends to two sides of the cover 331 and extends to two lateral side edges of the touch-sensing cover 33 to enlarge the area where the user executes the operating. FIG. 9B is a schematic view showing the shadeless touch hand-held electronic device of FIG. 9A at another viewing angle. Referring to FIG. 9B, in order to arrange the touch-sensing structure 332 using a width W1 of the cover 331 more effectively, a width W2 of the touch-sensing structure 332 may be slightly less than the width W1 of the cover 331 by 5% to 10%, for example. That is, the width W2 of touch-sensing structure 332 is less than the width W1 of the cover 331 that means W2 is about 90% to 95% of the width W1 of the cover 331. In other embodiments, the physical button may also be replaced with the touch-sensing structure 332 of this embodiment. However, it is not limited thereto.

The wiring L connecting to the touch-sensing structure 332 may be gathered to a single side for wiring outlet, and then electrically connected to the circuit board to enhance the flexibility of wire design. For the sake of clarifying the drawing, the wiring L of FIG. 9B are shown in solid lines, and the wiring L of this embodiment are disposed on the inner surface of the cover 331. The arrangement relationship between the touch-sensing structure 332 and the cover 331 may be found in the first embodiment.

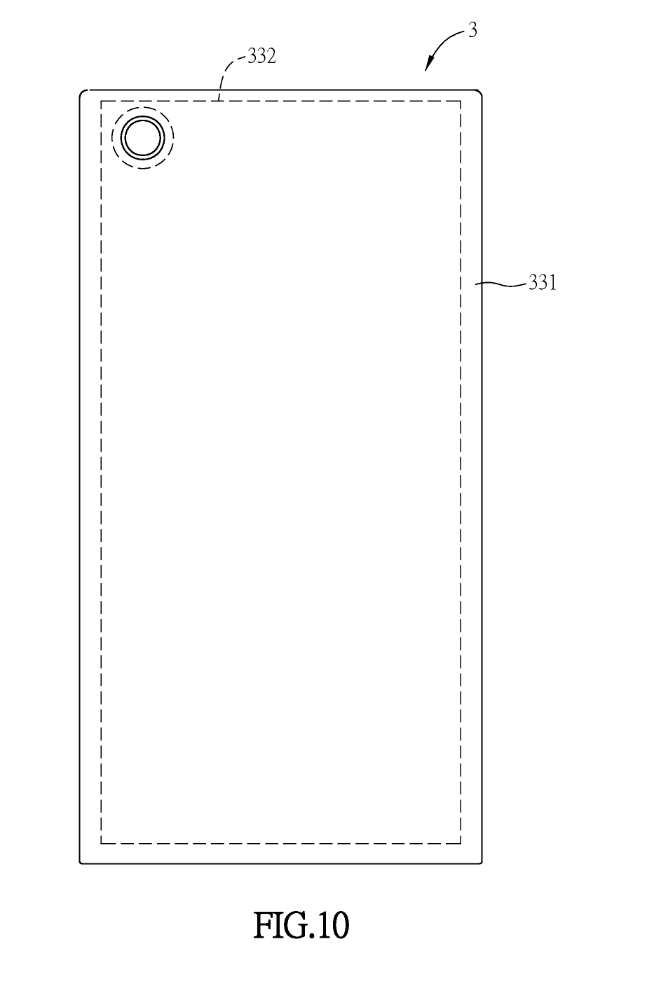

FIG. 10 is a schematic view showing another embodiment of the touch-sensing structure of FIG. 9A. Referring to FIG. 10, the touch-sensing structure 332 may also be arranged in conjunction with a position of a camera lens of the cover 331 or a position of a flash, so that no touch-sensing structure is disposed within a partial range (i.e., the position of the camera lens or the flash) within the range of the touch-sensing structure 332. The partial range may be the range in which the touch-sensing structure 332 is disposed, or the edges near the range in which the touch-sensing structure 332 is disposed.

In addition, as shown in FIG. 8, the touch-sensing structure 332 has multiple detection points P, which may be triggered by receiving the trigger events. For example, when a conductor, which may be, for example but without limitation to, a stylus or the user's finger, touches the touch-sensing structure 332, the detection point P at the touch position may be triggered to generate the signal of the trigger event, and the signal may be transmitted to the control unit 32, so that the control unit 32 judges or analyzes the trigger event. For example, the control unit 32 can compute a portion or all of the triggered detection points P to generate a computed result, which comprises a trigger quantity, a trigger quantity distribution, a trigger morphology (which can refer to trigger appearance), a trigger time, a trigger frequency or a trigger location (which can refer to trigger position) of the trigger event. Next, the control unit 32 compares the computed result with an initiative determination condition pre-stored in the hand-held electronic device 3. In some embodiments, if the computed result satisfies the initiative determination condition, then the hand-held electronic device 3 can receive other inputs from the touch-sensing structure 332, or otherwise the hand-held electronic device 3 does not receive any input from any other touch-sensing structure 332. In this manner, the data security of the hand-held electronic device 3 can be enhanced. The trigger event may be generated in correspondence with the user's gripping position when the user holds the touch-sensing cover 33, or may be generated when the user executes the input operation on the touch-sensing cover 33. However, it is not limited thereto.

As mentioned hereinabove, the touch-sensing cover 33 and the panel 31 are disposed on two opposite sides of the hand-held electronic device 3, respectively, to prevent the situation that the user's hand tends to shade the displayed object of the panel 31 when the user operates the hand-held electronic device 3, and can further prevent the inadvertent touch condition.

In addition, as shown in FIG. 8, the hand-held electronic device 3 of this embodiment further has a storage unit 34, which may be, for example but without limitation to, a read-only memory (ROM), a random access memory (RAM), a flash memory, a field-programmable gate array (FPGA) or any other memory. However, it is not limited thereto. The storage unit 34 of this embodiment is a random access memory (RAM) described as an example, and is coupled to the control unit 32 via a signal bus similarly.

In this embodiment, the storage unit 34 stores the operation system, the application program, the data processing program, electronic data of various formats and the like. In some embodiments, the storage unit 34 may further store the initiative determination condition. The operation system is a program for managing the computer hardware, firmware and the software resource, and the application program may be, for example, a text editing program, an e-mail program or other programs. The data processing program of this embodiment represents the program for detecting the data structure of the electronic data and generating the corresponding connection instruction. In this embodiment, the control unit 32 is a central processing unit (CPU), for example, and the control unit 32 executes these programs.

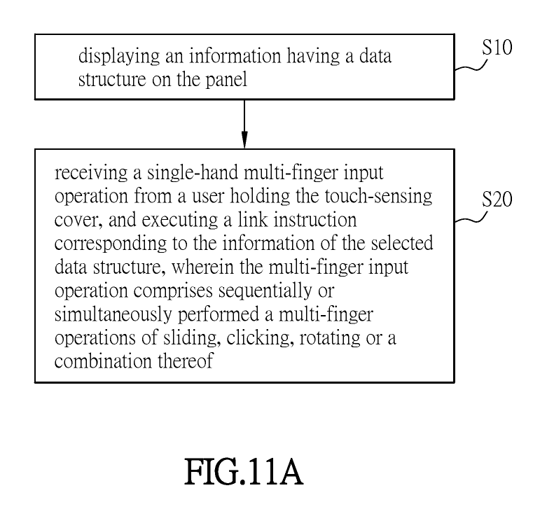

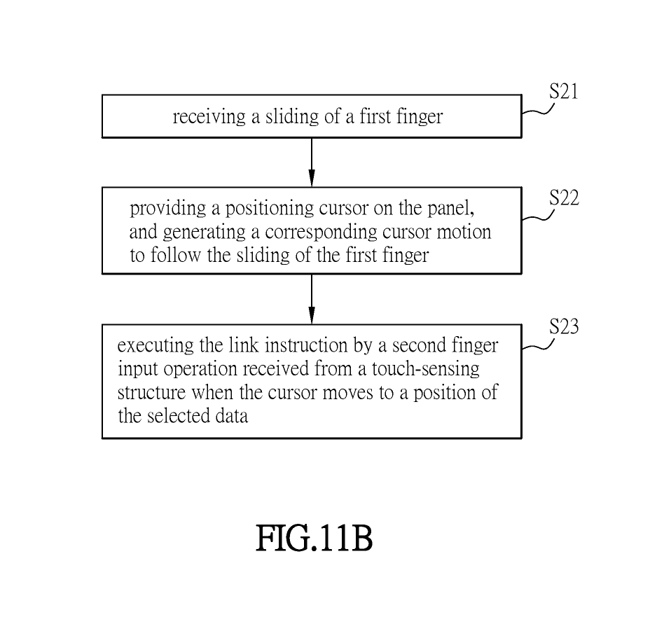

FIGS. 11A and 11B are flow charts showing steps of a computer-executed method according to the preferred embodiment of the invention. Referring to FIG. 11A, the computer-executed method of this embodiment executes, in the hand-held electronic device 3, the following steps of: displaying information, having a data structure, on the panel (step S10); and receiving a single-hand multi-finger input operation from a user holding the touch-sensing cover and executing the link instruction corresponding to the selected data structure. The multi-finger input operation comprises sequentially or simultaneously performed a multi-finger operations of sliding, clicking, rotating or a combination thereof (step S20). Of course, in other embodiments, the above-mentioned steps may also be executed in the hand-held electronic device 1. However, it is not limited thereto.

The combination of the multi-finger input operations comprises, for example but without limitation to, the following operations. The first finger firstly slides to the position of the information having a data structure (i.e., the position of the selected data), and then the second finger clicks to perform the operation of selecting the information. That is, the slide (first finger) is firstly executed, and then the clicking (second finger) is executed. Alternatively, the first finger firstly slides to the position of the information having a data structure, and then the second finger slides to perform the transmitting operation, for example, on the selected data corresponding to the position of the first finger. That is, the first finger slide is executed, and then the second finger slide is executed. The first finger may also firstly click the position of the information having a data structure, and then the second finger slides to perform the transmission operation on the selected data corresponding to the first finger click, for example. That is, the first finger click is executed, and then the second finger slide is executed. Alternatively, the first finger firstly clicks the position of the information having a data structure, and then the second finger clicks to execute the link instruction corresponding to the selected data structure. That is, the first finger click is executed, and then the second finger click is executed. The above-mentioned multi-finger input operations are performed in order. However, when the first finger clicks (the position corresponding to the information having a data structure), the second finger may also simultaneously perform the slide. In this case, the transmitting operation of the selected data corresponding to the click of the first finger may also be similarly performed, for example.

After the first finger firstly sliding to the position of the selected data and the second finger clicking to confirm, if the confirmation needs to be cancelled, then the second finger may perform a click operation to cancel the previous confirmation. Alternatively, the rotating operation of the first finger about the second finger can be similarly defined as canceling the previous confirmation without designing a new software recovery menu mechanism to correct the inadvertent touch.

Referring to FIG. 11B, in the step S20, the multi-finger input operation comprises: receiving the slide from the first finger (step S21); providing a positioning cursor on the panel, and then generating a corresponding cursor motion to follow sliding of the first finger (step S22); and executing the link instruction according to the second finger input operation received on the touch-sensing structure when the cursor moves to a position of the selected data (step S23).

Alternatively, the multi-finger input may also comprise concurrent sliding of three fingers to turn on the linked electronic device (e.g., television) and to perform the corresponding control or data transmission.

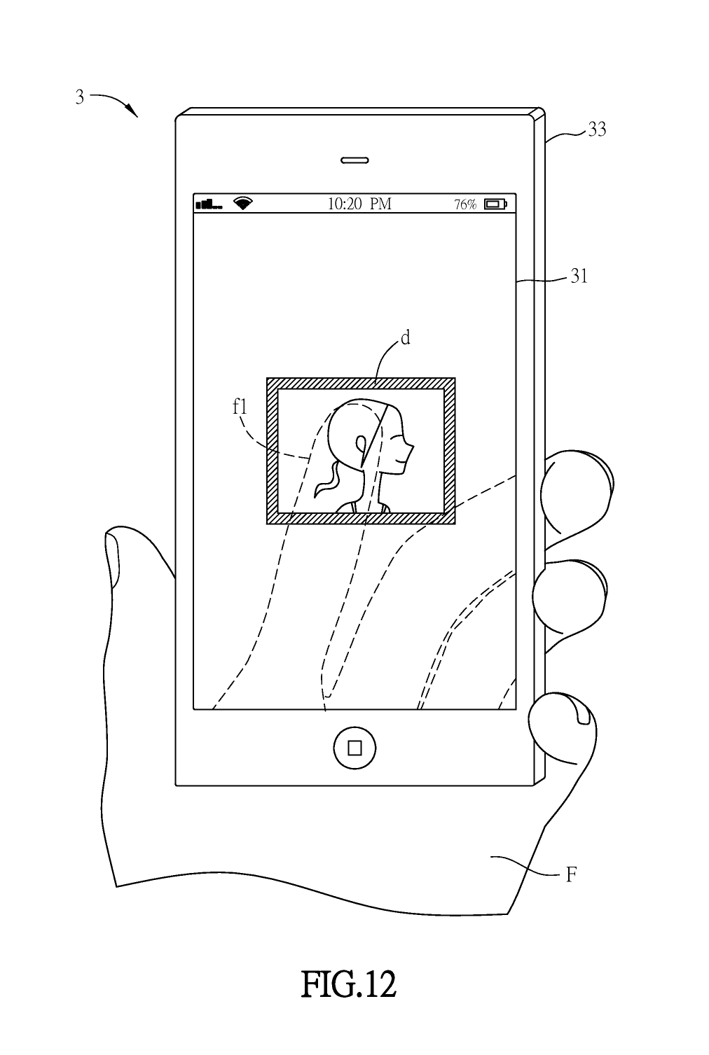

In addition, the steps executed may further comprise: transmitting the selected data to a targeted electronic device (step S30). FIG. 12 is a schematic views showing operations of the shadeless touch hand-held electronic device of FIG. 7. Please refer to FIGS. 8 and 12 concurrently. In this embodiment, the panel 31 of the hand-held electronic device 3 displays the information having a data structure (step S10), the information may be a text or an image, and may be a virtual keyboard, a short message, an e-mail, an application program or the like, for example. The virtual keyboard may be disposed on the upper portion of the panel 31 to achieve the effect of facilitating the user's finger in operating and clicking the panel. The control unit 32 may analyze the data structure of the information (i.e., the data structure, such as digits, texts, image data, audio, video, string data or the like). Next, the user can firstly execute the input through the touch-sensing cover 33, to select the data to be transmitted to a targeted electronic device 4 (steps S20 to S40). The user can transmit the selected data d in the hand-held electronic device 3 to the targeted electronic device 4. Herein, the targeted electronic device 4 is similarly described as a smart phone, and the targeted electronic device 4 and the hand-held electronic device 3 may have the same elements and linking relationships. The targeted electronic device 4 and the hand-held electronic device 3 may also have different elements and linking relationships, or even the targeted electronic device 4 may be not a smart phone. However, it is not limited thereto. The selected data d to be transmitted to the targeted electronic device 4 may be digits, texts, image data, audio video, string data or various digital formats. The selected data d in the example of FIG. 12 is a photo stored in the hand-held electronic device 3. However, it is not limited thereto.

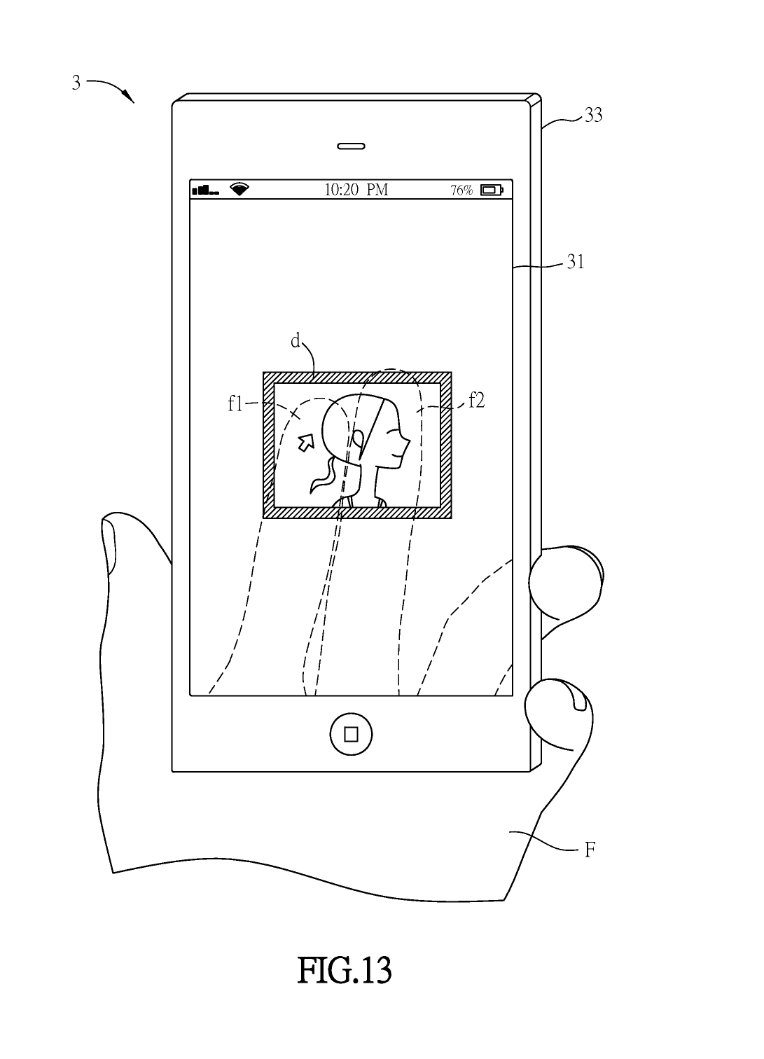

In the example of FIG. 12, the user holds the hand-held electronic device 3 by one hand F, and uses the finger f1 of the one hand F to select the photo by way of clicking on the touch-sensing cover 33, and the selected photo is the selected data d. The selecting method of FIG. 12 may also be referred to as a “single-finger selection”. FIG. 13 is another schematic view showing operations of the shadeless touch hand-held electronic device of FIG. 7. The selecting method of FIG. 13 is different from FIG. 12 in that the selecting method is a “multi-finger selection (such as but without limitation to a dual-finger selection”. In detail, the user uses two fingers f1 and f2 (especially the middle finger and the index finger) of the one hand F to select the photo by performing sliding and clicking operations on the touch-sensing cover 33, and the selected photo is the selected data d. In detail, when the input is performed using multiple fingers to click the touch-sensing cover 33, the first finger (e.g., index finger) moves the position of the selected data d by way of sliding. At this time, the panel 31 displays the corresponding cursor motion, and the cursor may be an arrow symbol of FIG. 13, which has moved to the position of the selected data (step S30). Next, the selected data is clicked to perform the selection operation, and the second finger (e.g., middle finger) clicks to perform the confirmation operation (step S40). In some embodiments, the hand-held electronic device 3 may further comprise an eyeball tracking element, such as an eye tracker, a photographing device or an infrared detection device. The eyeball tracking element can track the eyeball information of the user. Thus, the user may also select the data on the panel 31 through the eyeball tracking element. However, it is not limited to the above-mentioned selecting method.

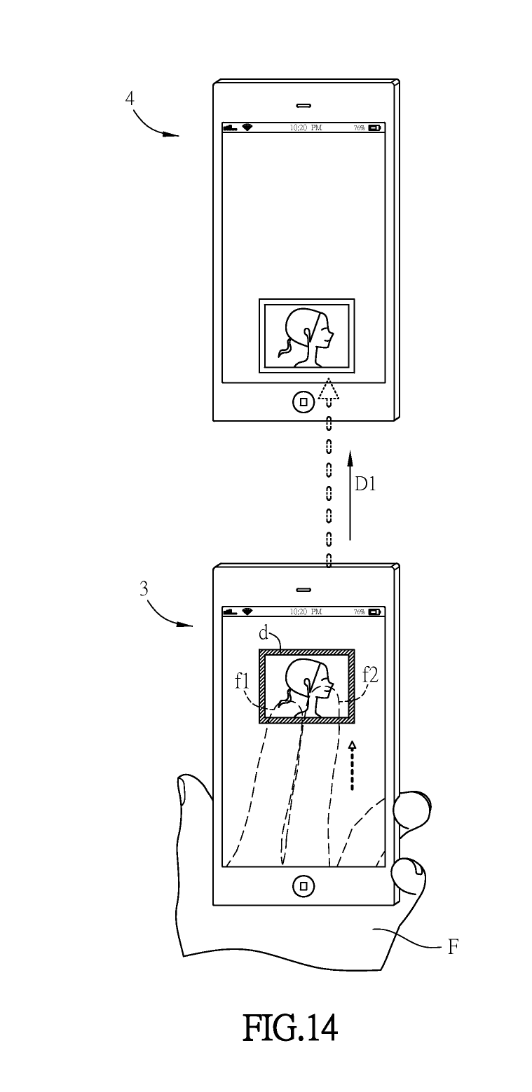

When the user applies either the method of FIG. 12 or 13, or other methods to select the to-be-transmitted data, the panel 31 displays the selected data d. Next, referring to FIG. 14, FIG. 14 is still another schematic view showing operations of the shadeless touch hand-held electronic device of FIG. 7. The user adopts two fingers f1 and f2 of one hand F to execute the slide and click operations (multi-finger input operation) on the touch-sensing cover 33. In this embodiment, the data structure of the information has the link instruction linked with “Transmit”. That is, the control unit 32 can analyze the data structure of the information, and can further execute the “Transmit” link instruction when the second finger (e.g., middle finger) clicks to confirm, so that the selected data d can be transmitted to the targeted electronic device 4.

Referring to FIGS. 8 and 14 concurrently. In some embodiments, the hand-held electronic device 3 may further comprise a wireless module 35 electrically connected to the control unit 32. The wireless module 35 may be at least one of an infrared module, a Bluetooth module, an infrared module, a ZigBee module, a radio frequency module and a near field communication module. In the practical application, the targeted electronic device 4 may have another wireless module corresponding to the wireless module 35 of the hand-held electronic device 3. The hand-held electronic device 3 can communicate with another wireless module of the targeted electronic device 4 through the wireless module 35, and transmit the selected data d to the targeted electronic device 4 through the wireless module 35. In detail, the hand-held electronic device 3 can firstly establish the linking relationship with the targeted electronic device 4 through the wireless module 35, and then the control unit 32 starts to execute the steps of FIGS. 11A and 11B.

In one embodiment, if the wireless module 35 of the hand-held electronic device 3 is the near field communication (NFC) module, then the NFC module may further comprise a user identification key, which is automatically linked to the targeted electronic device 4 through the wireless module 35 to restrict or manage the user, who also holds the hand-held electronic device 3, in manipulating the targeted electronic device 4. In the practical application, the NFC module has a near field communication chip and an antenna. The near field communication chip is electrically connected to the control unit 32, and the antenna may be disposed on the cover 331 or the touch-sensing structure 332. However, it is not limited thereto. When the user wants to perform the near field communication between the hand-held electronic device 3 and the targeted electronic device 4, the user can move the hand-held electronic device 3 to a location near the targeted electronic device 4 having the near field communication function to perform electronic data transmitting or receiving with the targeted electronic device 4 through the antenna and the near field communication chip.

Referring again to FIG. 8, the hand-held electronic device 3 may further comprise a sensing unit 36. The sensing unit 36 electrically connected to the control unit 32 generates and transmits a transmission signal to the control unit 32 by the multi-finger input operation on the touch-sensing cover 33. The control unit 32 transmits the selected data to the targeted electronic device 4 according to the transmission signal.

In one embodiment, the sensing unit 36 is further electrically connected to the touch-sensing structure 332. Next, referring to FIG. 14, the user holds the hand-held electronic device 3 facing the targeted electronic device 4, and uses two fingers f1 and f2 of one hand F to perform the multi-finger input operation on the touch-sensing cover 33 in the direction Dl from the hand-held electronic device 3 to the targeted electronic device 4. In this manner, the selected data d may be transmitted from the hand-held electronic device 3 to the targeted electronic device 4. The sensing unit 36 can sense the sliding direction or sliding angle of the multi-finger input, and generate a transmission signal according to the sliding direction or sliding angle. Herein, the sliding direction represents the direction of the targeted electronic device 4 relative to the hand-held electronic device 3, and the sliding angle represents the angle of the targeted electronic device 4 relative to the hand-held electronic device 3. After receiving the transmission signal, the control unit 32 can transmit the selected data d to the targeted electronic device 4 corresponding to the sliding direction information or sliding angle information according to the sliding direction information or sliding angle information contained in the transmission signal. To get close to the practical application in some embodiments, an error between the direction or angle of the multi-finger input operation and the direction or angle of the targeted electronic device 4 relative to the hand-held electronic device 3 may be permitted. That is, when the error therebetween falls within the error range, the selected data d is also permitted to be transmitted from the hand-held electronic device 3 to the targeted electronic device 4.

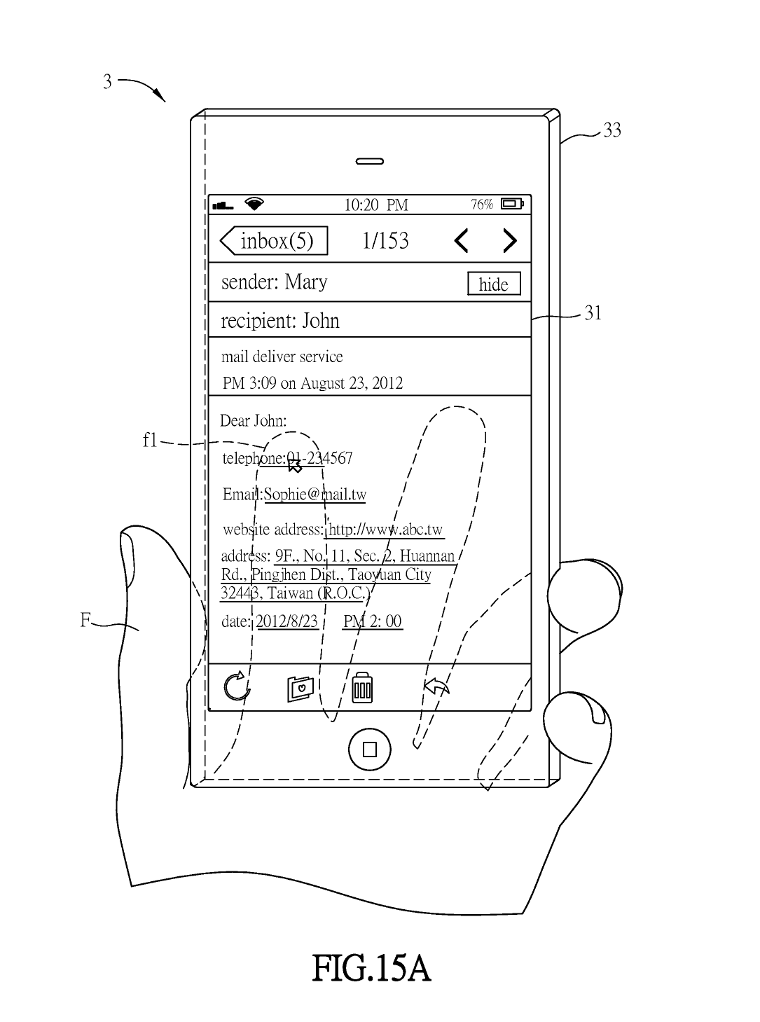

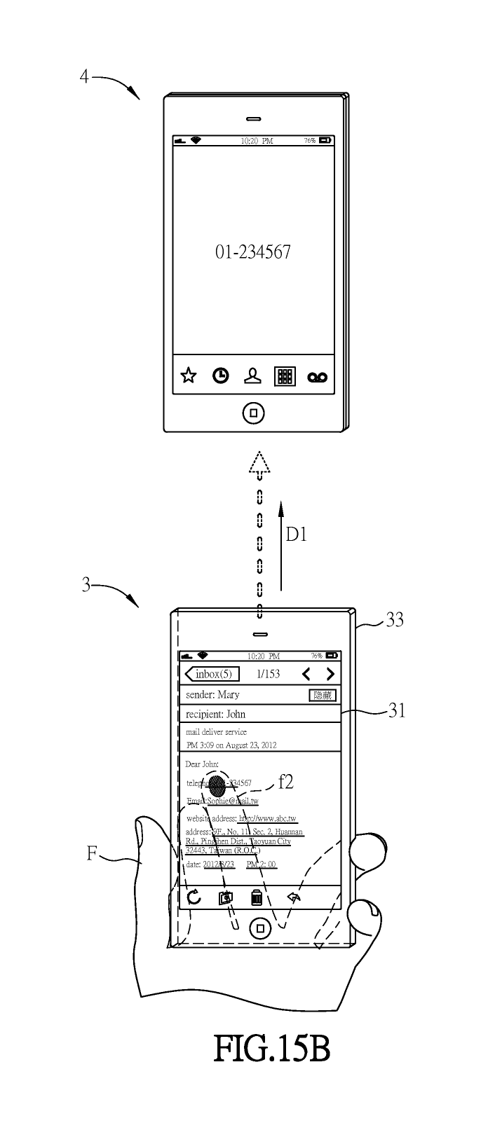

FIGS. 15A and 15B are other schematic views showing operations of the shadeless touch hand-held electronic device of FIG. 7. Referring to FIGS. 8, 15A and 15B concurrently. In this embodiment, the information is the text file stored in the hand-held electronic device 3, and the control unit 32 can analyze the grammar or string in the information, and compare the information with grammars or predetermined string patterns pre-stored in the hand-held electronic device to detect the data structure of the information having these grammars or these predetermined strings. The specific grammars or predetermined string patterns of this embodiment comprise a telephone number, an address, an e-mail address, a uniform resource location (URL) or the like, these data structures are marked by underlines or other methods (see FIG. 15A). In detail, the storage unit 34 stores a grammar file and a string library, wherein the grammar file has grammars, and the string library has predetermined string patterns. In addition, the storage unit 34 simultaneously stores the link instructions corresponding to the grammars and predetermined string patterns. In this embodiment, the link instruction is the “Transmit” link instruction to link to the corresponding “Transmit” operation.

When the user is operating, the user can use the finger f1 of the one hand F to perform the operation on the touch-sensing cover 33, and a corresponding cursor motion (the arrow symbol in FIG. 15A) is generated to follow the sliding of the first finger (e.g., finger f1). When the cursor moves to the position of the selected data (e.g., the telephone number in FIG. 15A), the link instruction (i.e., “Transmit” link instruction) corresponding to the selected data structure is executed according to the input operation of a second finger (e.g., the finger f2 in FIG. 15A) received by the touch-sensing structure 332. For example, if the selected data is the telephone number and when the user uses the second finger to tap the position of the telephone number, the control unit 32 can correspondingly execute the “Transmit” link instruction, linked with the telephone number, to transmit the telephone number to the targeted electronic device 4. Thus, the control unit 32 in this embodiment can analyze the data structure of the information to find the meaningful specific grammars or predetermined string patterns, such as the telephone number, address, e-mail address, uniform resource location or the like, to be shared with another device (e.g., targeted electronic device 4), so that the information of the telephone number, address, e-mail address, uniform resource location or the like can be transmitted to the targeted electronic device 4.

According to the above-mentioned contents, the disclosure provides novel data transmission between the devices. More particularly, the user only needs to use two fingers of the one hand holding the hand-held electronic device to slide on the touch-sensing cover, and can transmit the selected data to the targeted electronic device. The user needs not to adopt two hands simultaneously, and the multi-finger input operation is executed on the touch-sensing cover. Hence, there is no problem that the finger will shade the view, and the single-hand multi-finger manipulating convenience and the information selecting accuracy can be enhanced.

In addition, the disclosure further provides a touch-sensing cover of the shadeless touch hand-held electronic device, wherein the shadeless touch hand-held electronic device comprises the touch-sensing cover, a panel and a control unit. The control unit is electrically connected to the touch-sensing cover and the panel. The touch-sensing cover comprises a cover and a touch-sensing structure. The cover is disposed on the other side of the hand-held electronic device opposite the panel. Partial or total area of the touch-sensing structure is disposed on the cover. The control unit displays information, having a data structure, on the panel, and receives the single-hand multi-finger input operation from the holding touch-sensing cover, and executes a link instruction corresponding to the selected data structure. The multi-finger input operation comprises sliding or clicking of a first finger, sliding or clicking of a second finger and a combination thereof. The input operations of the first finger and the second finger are performed in order or simultaneously.

In summary, in the shadeless touch hand-held electronic device and its touch-sensing cover, the user can perform the touch operation on the touch-sensing cover of the shadeless touch hand-held electronic device. So, the finger cannot shade the view or the software target or software object displayed on the panel. Of course, the inadvertent touch phenomenon will not occur when opening the link of the high information density content. In addition, because the electronic device is operated on the touch-sensing cover, the dependency on the stylus can be decreased, and the panel scratching problems can be decreased. In addition, because the user can perform the touch operation on the touch-sensing cover, the user can use just one hand to hold the device and use the index finger and/or middle finger of the same hand to operate the electronic device. Compared with the conventional condition where only the thumb of one hand can be used to perform the manipulation, the disclosure also has the relatively high efficiency and convenience of the manual operation. Also, the convenience of single-hand multi-finger manipulation and the information selecting accuracy are also enhanced, and the high quality and wonderful user experience can be implemented.

In addition, in one embodiment, the shadeless touch hand-held electronic device is accessible in the strong light environment, for example, the device is under the outdoor sun or the indoor strong illumination lamp. When the user operates the shadeless touch hand-held electronic device by one hand and the touch-sensing cover faces the light source in the strong light environment (the panel faces the user), the back of the panel faces the light source of the strong light environment, the touch-sensing cover can shield and block the light source to enhance the readability, and the operation or input control can be continuously performed with one hand. Moreover, the user can use only one hand to hold the device, and the index finger and/or middle finger of the same hand can perform the input. Thus, the convenience of operating the shadeless touch hand-held electronic device under the strong light source (e.g., sunlight) by one hand can be enhanced. In addition, the operating flexibility using the index finger or middle finger on the touch-sensing cover is significantly increased as compared with the operating flexibility using the thumb in the conventional single-hand manipulation, and the novel user experience of the single-hand holding and multi-finger touching can be created. In addition, the wireless transmission between the functional component disposed on the second portion of the cover and another electronic device can be performed to enhance the operation convenience.

Furthermore, the invention uses the single-hand holding and multi-finger touch gesture to wirelessly transmit the data to other electronic devices, so that the manipulation convenience of the data sharing among the user communities can be expanded.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A shadeless touch hand-held electronic device, comprising:
a touch-sensing cover having a cover and a touch-sensing structure, wherein partial or total area of the touch-sensing structure is disposed on the cover;
a panel disposed on the other side of the hand-held electronic device opposite the touch-sensing cover; and
a control unit electrically connected to the touch-sensing cover and the panel, and executes steps comprising:
displaying an information having a data structure on the panel; and
receiving a single-hand multi-finger input operation from a user holding the touch-sensing cover, and executing a link instruction corresponding to the information of the selected data structure, wherein the multi-finger input operation comprises sequentially or simultaneously performed a multi-finger operations of sliding, clicking, rotating or a combination thereof.

2. The hand-held electronic device of claim 1, wherein the multi-finger input operation comprises:
receiving a sliding of a first finger;
providing a positioning cursor on the panel, and generating a corresponding cursor motion to follow the sliding of the first finger; and
executing the link instruction by a second finger input operation received from the touch-sensing structure when the cursor moves to a position of the selected data.

3. The hand-held electronic device of claim 1, wherein the steps further comprises:
transmitting the selected data to a targeted electronic device.

4. The hand-held electronic device of claim 3, further comprising:
a sensing unit, signaling the control unit and generating a transmission signal by the multi-finger input operation, wherein the control unit transmits the selected data to the targeted electronic device according to the transmission signal.

5. The hand-held electronic device of claim 4, wherein the transmission signal is generated according to a sliding direction or a sliding angle by the multi-finger input operation.

6. The hand-held electronic device of claim 1, wherein the user operates the hand-held electronic device by one hand and the touch-sensing cover faces a light source, or the back of the panel faces the light source.

7. The hand-held electronic device of claim 1, wherein a wiring connecting to the touch-sensing structure is gathered to a single side for wiring outlet.

8. The hand-held electronic device of claim 1, wherein the width of the touch-sensing structure is less than the width of the cover by 5% to 10%.

9. The hand-held electronic device of claim 1, wherein the area of the touch-sensing structure and area of the panel have a ratio relationship.

10. The hand-held electronic device of claim 1, wherein the touch-sensing structure comprises metal mesh, metal nanowires, transparent conducting film, carbon nanotube or graphene.

11. The hand-held electronic device of claim 1, wherein the touch-sensing cover further comprises a functional component, the cover comprises a first portion and a second portion, and the functional component is disposed on the second portion.

12. The hand-held electronic device of claim 11, wherein partial or total area of the touch-sensing structure is disposed on the first portion.

13. The hand-held electronic device of claim 11, wherein the functional component comprises a radio frequency identification module, a near field communication module, an antenna module, a Bluetooth module, an infrared module, a zigbee module, a wireless charging module, a palmprint recognition module or a combination thereof.

14. A computer-executed method, applied to a shadeless touch hand-held electronic device for a single hand multi-finger operation, the hand-held electronic device comprising a touch-sensing cover, a panel and a control unit, the method executed on the hand-held electronic device comprising following steps of:
displaying an information having a data structure on the panel; and
receiving a single-hand multi-finger input operation from a user holding the touch-sensing cover, and executing a link instruction corresponding to the information of the selected data structure, wherein the multi-finger input operation comprises sequentially or simultaneously performed a multi-finger operations of sliding, clicking, rotating or a combination thereof.

15. The method of claim 14, wherein the multi-finger input operation comprises:
receiving a sliding of a first finger;
providing a positioning cursor on the panel, and generating a corresponding cursor motion to follow the sliding of the first finger; and
executing the link instruction by a second finger input operation received from a touch-sensing structure when the cursor moves to a position of the selected data

16. The method of claim 14, further comprising a step of:
transmitting the selected data to a targeted electronic device.

17. The method of claim 16, wherein the hand-held electronic device further comprises a sensing unit, wherein the sensing unit is signaling the control unit, and generating a transmission signal by the multi-finger input operation wherein the control unit transmits the selected data to the targeted electronic device according to the transmission signal.

18. The method of claim 17, wherein the transmission signal is generated according to a sliding direction or a sliding angle by the multi-finger input operation.

19. The method of claim 14, wherein the touch-sensing cover has a cover and a touch-sensing structure, and the area of the touch-sensing structure and area of the panel have a ratio relationship.

20. The method of claim 14, wherein the touch-sensing structure comprises metal mesh, metal nanowires, transparent conducting film, carbon nanotube or graphene.
